(19) United States
(12) Patent Application Publication
(10) Pub. No.: US 2024/0133062 A1
(43) Pub. Date: Apr. 25, 2024

(54) MULTI-LAYER ELECTROCHEMICAL DEVICE AND METHOD OF MAKING

(71) Applicant: Utility Global, Inc., Houston, TX (US)

(72) Inventors: Matthew Dawson, Katy, TX (US); Jin Dawson, Katy, TX (US); Hsuan-Yu Leu, Richmond, TX (US)

(73) Assignee: Utility Global, Inc., Houston, TX (US)

(21) Appl. No.: 18/364,631

(22) Filed: Aug. 3, 2023

Related U.S. Application Data
(60) Provisional application No. 63/416,857, filed on Oct. 17, 2022.

(51) Int. Cl. C25B 13/07; C25B 9/19; C25B 11/031

(52) U.S. Cl. CPC C25B 13/07; C25B 9/19; C25B 11/031

(57) ABSTRACT

Herein discussed is a method of making an electrochemical device comprising (a) infiltrating an anode precursor, a cathode precursor, and an electrolyte precursor with a dispersion to produce an infiltrated anode precursor, an infiltrated cathode precursor, and an infiltrated electrolyte precursor, wherein the dispersion comprises metal ions and nanoparticles selected from the group consisting of metallic nanoparticles, metal-oxide nanoparticles, ceramic nanoparticles, and combinations thereof; wherein the metal ions percolate each precursor, wherein the anode precursor, the cathode precursor, and the electrolyte precursor are porous, the electrolyte precursor having an average pore size that is 50% or less of an average pore size of the anode precursor and that is 50% or less of an average pore size of the cathode precursor; and (b) co-sintering the infiltrated anode precursor, the infiltrated cathode precursor, and the infiltrated electrolyte precursor such that the infiltrated anode precursor becomes a porous anode, the infiltrated cathode precursor becomes a porous cathode, and a gas tight electrolyte is formed between the porous anode and the porous cathode.

### CROSS-REFERENCE TO RELATED APPLICATIONS

This application claims the benefit under 35 U.S.C. 119(e) of U.S. Provisional Patent Application No. 63/416,857 filed Oct. 17, 2022, the entire disclosure of which is hereby incorporated herein by reference.

### TECHNICAL FIELD

This invention generally relates to electrochemical devices. More specifically, this invention relates to electrochemical devices having multiple layers and methods of making such.

### BACKGROUND

Traditionally, electrochemical devices are utilized to generate electricity from chemical reactions, such as batteries and fuel cells; or utilize electrical energy to cause chemical reactions, such as electrolysers. These devices contain an electrolyte that does not conduct electrons. These traditional devices also need current collectors or interconnects to generate or receive electricity.

The electrochemical devices of this disclosure are directed to devices having mixed-conducting electrolytes. These devices do not generate electricity nor consume electricity but rather utilize electrochemical pathways for reactions. They also do not contain current collectors or interconnects, which make them simple and more economical. As such, there is interest in developing such devices and methods of making such devices.

### SUMMARY

Herein discussed is a method of making an electrochemical device comprising (a) infiltrating an anode precursor, a cathode precursor, and an electrolyte precursor with a dispersion to produce an infiltrated anode precursor, an infiltrated cathode precursor, and an infiltrated electrolyte precursor, wherein the dispersion comprises metal ions and nanoparticles selected from the group consisting of metallic nanoparticles, metal-oxide nanoparticles, ceramic nanoparticles, and combinations thereof; wherein the metal ions percolate each precursor, and (b) co-sintering the infiltrated anode precursor, the infiltrated cathode precursor, and the infiltrated electrolyte precursor such that the infiltrated anode precursor becomes a porous anode, the infiltrated cathode precursor becomes a porous cathode, and a gas tight electrolyte is formed between the porous anode and the porous cathode.

In an embodiment, the porous anode, the porous cathode, and the gas-tight electrolyte have the same elements. In an embodiment, the gas-tight electrolyte is mixed-conducting. In an embodiment, the gas-tight electrolyte conducts electrons and ions. In an embodiment, the average pore size of the electrolyte precursor is in the range of 10-200 nm, or 10-100 nm, or 10-50 nm. In an embodiment, the average pore size of the anode precursor or of the cathode precursor is in the range of 20 nm-2 μm, or 30 nm-1 μm, or 30-300 nm.

In an embodiment, the anode precursor, the cathode precursor, and the electrolyte precursor are heated prior to the infiltration step such that pore formers present in the anode precursor, the cathode precursor, and the electrolyte precursor are vacated to produce pores in the anode precursor, the cathode precursor, and the electrolyte precursor. In an embodiment, the anode precursor, the cathode precursor, and the electrolyte precursor comprise YSZ (yttria-stabilized zirconia), CGO (Gadolinium-Doped Ceria), SDC (samaria-doped ceria), SSZ (scandia-stabilized zirconia), LSGM (lanthanum strontium gallate magnesite), ScCeSZ (Sc and Ce doped zirconia), or combinations thereof.

In an embodiment, the metal ions comprise nickel ions, copper ions, silver ions, cobalt ions, iron ions, or combinations thereof. In an embodiment, the nanoparticles comprise nickel nanoparticles, NiO nanoparticles, CGO nanoparticles, CoCGO nanoparticles, YSZ nanoparticles, copper nanoparticles, copper oxide nanoparticles, LST (lanthanum-doped strontium titanate) nanoparticles, SCZ (scandia-ceria-stabilized zirconia) nanoparticles, silver nanoparticles, LSCF (Lanthanum Strontium Cobalt Ferrite) nanoparticles, nickel/iron alloy nanoparticles, cobalt nanoparticles, platinum nanoparticles, ZrO₂ nanoparticles, CeO₂ nanoparticles, or combinations thereof.

In an embodiment, infiltration is prompted by applying a pressure differential, stirring, agitation, sonication, heating, capillary forces, solid-liquid cohesive forces, or a combination of any two or more thereof. In an embodiment, co-sintering takes place in an inert atmosphere or a reducing atmosphere.

In an embodiment, the method comprises providing a porous substrate for at least one of the anode precursor, the cathode precursor, and the electrolyte precursor as structural support. In an embodiment, the porous substrate is co-sintered with the infiltrated precursors and remains porous after co-sintering. In an embodiment, the electrolyte precursor has a thickness of no more than 30 μm, or no more than 10 μm, or no more than 5 μm. In an embodiment, the anode precursor or the cathode precursor has a thickness of no more than 50 μm, or no more than 30 μm, or no more than 20 μm.

In an embodiment, the porous anode and the porous cathode have a porosity of no less than 20 vol. %, or no less than 30 vol. %, or no less than 35 vol. %, or no less than 40 vol. %. In an embodiment, the device comprises no current collector and no interconnect. In an embodiment, the porous anode, the porous cathode, and the gas-tight electrolyte are tubular.

Also discussed herein is an electrochemical device comprising a porous anode, a porous cathode, and an electrolyte between the porous anode and the porous cathode, wherein the porous anode, porous cathode, and electrolyte have the same elements, wherein the electrolyte is mixed-conducting and is gas tight. In an embodiment, the electrolyte conducts electrons and ions. In an embodiment, the device comprises no current collector and no interconnect.

In an embodiment, the porous anode and the porous cathode are both exposed to reducing environments during the entire time when the device is in operation. In an embodiment, the porous anode, porous cathode, and electrolyte are planar. In an embodiment, the porous anode, porous cathode, and electrolyte are tubular.

In an embodiment, the porous anode, porous cathode, and electrolyte comprise a ceramic matrix percolated by a metal. In an embodiment, the ceramic matrix comprises YSZ, CGO, SDC, SSZ, LSGM, ScCeSZ, or combinations thereof. In an embodiment, the metal comprises Ni, Cu, Ag, Co, Fe, or combinations thereof. In an embodiment, the porous anode and the porous cathode have a porosity of no less than 20 vol. %, or no less than 30 vol. %, or no less than 35 vol. %, or no less than 40 vol. %.

In an embodiment, the device comprises a porous substrate as structural support. In an embodiment, the electrolyte has a thickness of no more than 30 μm, or no more than 10 μm, or no more than 5 μm. In an embodiment, the porous anode or the porous cathode has a thickness of no more than 50 μm, or no more than 30 μm, or no more than 20 μm.

Further aspects and embodiments are provided in the following drawings, detailed description, and claims. Unless specified otherwise, the features as described herein are combinable and all such combinations are within the scope of this disclosure.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1A illustrates a multi-layer structure having an anode precursor, an electrolyte precursor, and a cathode precursor for making an electrochemical device, according to an embodiment of this disclosure.

FIG. 1B illustrates a method of making an electrochemical device having multiple layers, according to an embodiment of this disclosure.

FIG. 2A illustrates a multi-layer electrochemical device in tubular shape, according to an embodiment of this disclosure.

FIG. 2B illustrates a cross section of a multi-layer electrochemical device in tubular shape, according to an embodiment of this disclosure.

FIG. 3A and FIG. 3B are SEM images showing an anode precursor, an electrolyte precursor, and a cathode precursor after pore formers are vacated and before they are infiltrated, according to an embodiment of this disclosure.

### DETAILED DESCRIPTION

### Overview

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like. As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, compositions and materials are used interchangeably unless otherwise specified. Each composition/material may have multiple elements, phases, and components. Heating as used herein refers to actively adding energy to the compositions or materials.

As used herein, YSZ refers to yttria-stabilized zirconia; SDC refers to samaria-doped ceria; SSZ refers to scandia-stabilized zirconia; LSGM refers to lanthanum strontium gallate magnesite; ScCeSZ refers to Sc and Ce doped zirconia.

As used herein, CGO refers to Gadolinium-Doped Ceria, also known alternatively as gadolinia-doped ceria, gadolinium-doped cerium oxide, cerium(IV) oxide, gadolinium-doped, GDC, or GCO, (formula Gd:CeO₂). CGO and GDC are used interchangeably unless otherwise specified. Syngas (i.e., synthesis gas) in this disclosure refers to a mixture consisting primarily of hydrogen, carbon monoxide and carbon dioxide.

A mixed conducting membrane is able to transport both electrons and ions. Ionic conductivity includes ionic species such as oxygen ions (or oxide ions), protons, halogenide anions, chalcogenide anions. In various embodiment, the mixed conducting membrane of this disclosure comprises an electronically conducting phase and an ionically conducting phase.

In this disclosure, the axial cross section of the tubulars is shown to be circular, which is illustrative only and not limiting. The axial cross section of the tubulars is any suitable shape as known to one skilled in the art, such as square, square with rounded corners, rectangle, rectangle with rounded corners, triangle, hexagon, pentagon, oval, irregular shape, etc.

As used herein, ceria refers to cerium oxide, also known as ceric oxide, ceric dioxide, or cerium dioxide, is an oxide of the rare-earth metal cerium. Doped ceria refers to ceria doped with other elements, such as samaria-doped ceria (SDC), or gadolinium-doped ceria (GDC or CGO). As used herein, chromite refers to chromium oxides, which includes all the oxidation states of chromium oxides.

A layer or substance being impermeable as used herein refers to it being impermeable to fluid flow. For example, an impermeable layer or substance has a permeability of less than 1 micro darcy, or less than 1 nano darcy.

In this disclosure, sintering refers to a process to form a solid mass of material by heat or pressure, or a combination thereof, without melting the material to the extent of liquefaction. For example, material particles are coalesced into a solid or porous mass by being heated, wherein atoms in the material particles diffuse across the boundaries of the particles, causing the particles to fuse together and form one solid piece.

The term “in situ” in this disclosure refers to the treatment (e.g., heating or cracking) process being performed either at the same location or in the same device. For example, ammonia cracking taking place in the electrochemical device at the anode is considered in situ.

Electrochemistry is the branch of physical chemistry concerned with the relationship between electrical potential, as a measurable and quantitative phenomenon, and identifiable chemical change, with either electrical potential as an outcome of a particular chemical change, or vice versa. These reactions involve electrons moving between electrodes via an electronically-conducting phase (typically, but not necessarily, an external electrical circuit), separated by an ionically-conducting and electronically insulating membrane (or ionic species in a solution). When a chemical reaction is effected by a potential difference, as in electrolysis, or if electrical potential results from a chemical reaction as in a battery or fuel cell, it is called an electrochemical reaction. Unlike chemical reactions, in electrochemical reactions electrons (and necessarily resulting ions), are not transferred directly between molecules, but via the aforementioned electronically conducting and ionically conducting circuits, respectively. This phenomenon is what distinguishes an electrochemical reaction from a chemical reaction.

Related to the electrochemical device and methods of use, various components of the device are described such as electrodes and membranes along with materials of construction of the components. The following description recites various aspects and embodiments of the inventions disclosed herein. No particular embodiment is intended to define the scope of the invention. Rather, the embodiments provide non-limiting examples of various compositions and methods that are included within the scope of the claimed inventions. The description is to be read from the perspective of one of ordinary skill in the art. Therefore, information that is well-known to the ordinarily skilled artisan is not necessarily included.

An interconnect in an electrochemical device (e.g., a fuel cell) is often either metallic or ceramic that is placed between the individual cells or repeat units. Its purpose is to connect each cell or repeat unit so that electricity can be distributed or combined. An interconnect is also referred to as a bipolar plate in an electrochemical device. An interconnect being an impermeable layer as used herein refers to it being a layer that is impermeable to fluid flow.

### Electrochemical Device and Method of Making

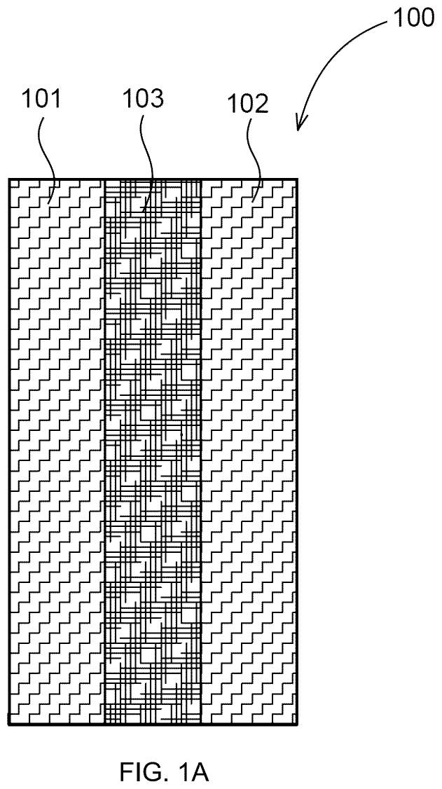

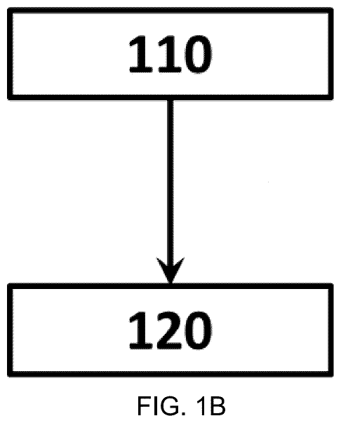

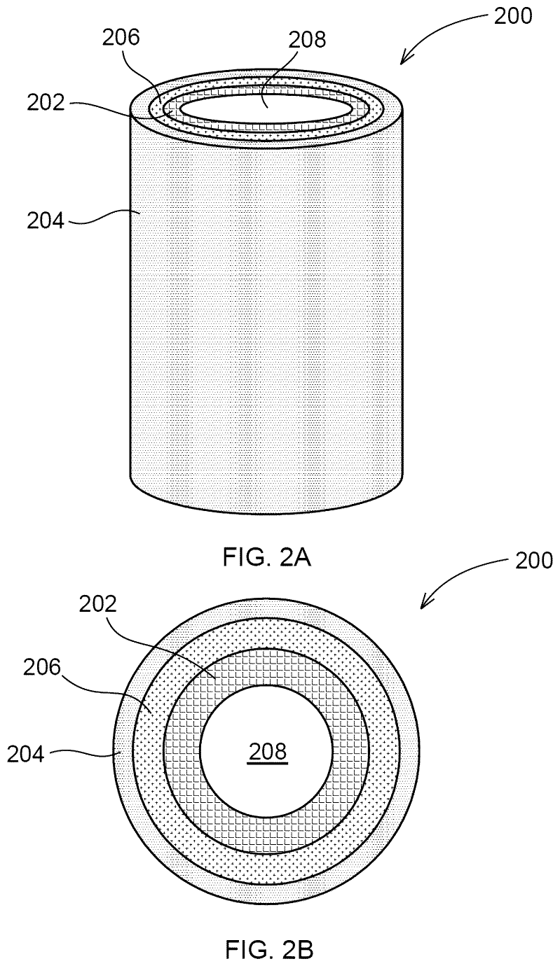

Contrary to conventional practice, an electrochemical device contains a mixed conducting membrane or electrolyte with an anode and a cathode on its two sides. FIG. 1A illustrates an electrochemical device 100 according to an embodiment of this disclosure. Device 100 comprises anode 101, cathode 102, and electrolyte 103. Electrolyte 103 is mixed conducting and gas tight. In some embodiments, electrolyte 103 conducts electrons and ions, e.g., oxide ions. In some embodiments, electrolyte 103 conducts electrons and protons. In an embodiment, the electrodes 101, 102 and the membrane 103 are tubular (see, e.g., FIGS. 2A and 2B). In an embodiment, the electrodes 101, 102 and the membrane 103 are planar. In various embodiments, the device comprises no current collector and no interconnect. In an embodiment, the device does not generate electricity and is not a fuel cell.

In various embodiments, the electrochemical reactions at the anode and the cathode are spontaneous without the need of electricity input. In various embodiments, the anode and cathode are both exposed to reducing environments during the entire time the device is in operation. In various embodiments, anode 101, cathode 102, and electrolyte 103 have the same elements. In various embodiments, anode 101, cathode 102, and electrolyte 103 comprise a ceramic matrix percolated by a metal. In an embodiment, the ceramic matrix comprises YSZ, CGO, SDC, SSZ, LSGM, ScCeSZ, or combinations thereof. In an embodiment, the metal comprises Ni, Cu, Ag, Co, Fe, or combinations thereof.

In an embodiment, the anode and the cathode have a porosity of no less than 20 vol. %. In an embodiment, the anode and the cathode have a porosity of or no less than 30 vol. %. In an embodiment, the anode and the cathode have a porosity of no less than 35 vol. %. In an embodiment, the anode and the cathode have a porosity of no less than 40 vol. %.

In an embodiment, the device has a porous substrate as structural support (not shown in FIG. 1A). In such cases, the electrolyte has a thickness of no more than 30 μm, or no more than 10 μm, or no more than 5 μm; the anode or the cathode has a thickness of no more than 50 μm, or no more than 30 μm, or no more than 20 μm. In these embodiments, the anode precursor, the cathode precursor, and the electrolyte precursor have similar thicknesses respectively.

FIG. 1B illustrates a process of making an electrochemical device according to an embodiment of this disclosure. Item 110 represents infiltrating an anode precursor, a cathode precursor, and an electrolyte precursor with a dispersion to produce an infiltrated anode precursor, an infiltrated cathode precursor, and an infiltrated electrolyte precursor. In various embodiments, the dispersion comprises metal ions and nanoparticles selected from the group consisting of metallic nanoparticles, metal-oxide nanoparticles, ceramic nanoparticles, and combinations thereof. In various embodiments, the metal ions percolate each precursor. In an embodiment, the majority of the nanoparticles accumulate in the electrolyte precursor. In an embodiment, the majority of the nanoparticles accumulate at the interfaces between the electrolyte and the electrodes. In various embodiments, the nanoparticles comprise nickel nanoparticles, NiO nanoparticles, CGO nanoparticles, CoCGO nanoparticles, YSZ nanoparticles, copper nanoparticles, copper oxide nanoparticles, LST nanoparticles, SCZ nanoparticles, silver nanoparticles, LSCF nanoparticles, nickel/iron alloy nanoparticles, cobalt nanoparticles, platinum nanoparticles, ZrO₂ nanoparticles, CeO₂ nanoparticles, or combinations thereof. In various embodiments, the electrolyte precursor is positioned between the anode precursor and the cathode precursor. In various embodiments, the porous electrolyte precursor has an average pore size that is 50% or less of the average pore size of the porous anode precursor and 50% or less of the average pore size of the porous cathode precursor.

With continued reference to FIG. 1B, item 120 represents co-sintering the infiltrated anode precursor, the infiltrated cathode precursor, and the infiltrated electrolyte precursor such that the infiltrated anode precursor becomes a porous anode, the infiltrated cathode precursor becomes a porous cathode, and a gas tight electrolyte is formed between the porous anode and the porous cathode providing a porous anode precursor, a porous cathode precursor, and a porous electrolyte precursor between the anode precursor and the cathode precursor. The formed gas-tight electrolyte is mixed conducting, e.g., electron conducting and ion conducting. The presence of nanoparticles from the infiltration step promotes the formation of a gas-tight layer between the anode and the cathode during the co-sintering step.

In various embodiments, the anode, cathode, and electrolyte have the same elements. In an embodiment, the average pore size of the porous electrolyte precursor is in the range of 10-200 nm. In an embodiment, the average pore size of the porous electrolyte precursor is in the range of 10-100 nm. In an embodiment, the average pore size of the porous electrolyte precursor is in the range of 10-50 nm. In an embodiment, the average pore size of the porous anode precursor or of the porous cathode precursor is in the range of 20 nm-2 μm. In an embodiment, the average pore size of the porous anode precursor or of the porous cathode precursor is in the range of 30 nm-1 μm. In an embodiment, the average pore size of the porous anode precursor or of the porous cathode precursor is in the range of 30-300 nm.

In some embodiments, the anode precursor, the cathode precursor, and the electrolyte precursor are heated prior to the infiltration step 110 such that pore formers are vacated to produce pores in each precursor. In various embodiments, the anode precursor, the cathode precursor, and the electrolyte precursor comprise YSZ, CGO, SDC, SSZ, LSGM, ScCeSZ, or combinations thereof. In various embodiments, the metal ions comprise nickel ions, copper ions, silver ions, cobalt ions, iron ions, or combinations thereof. In an embodiment, infiltration is prompted by applying pressure differential, stirring, agitation, sonication, heating, capillary forces, solid-liquid cohesive forces, or combinations thereof. In an embodiment, co-sintering takes place in an inert atmosphere or in a reducing atmosphere.

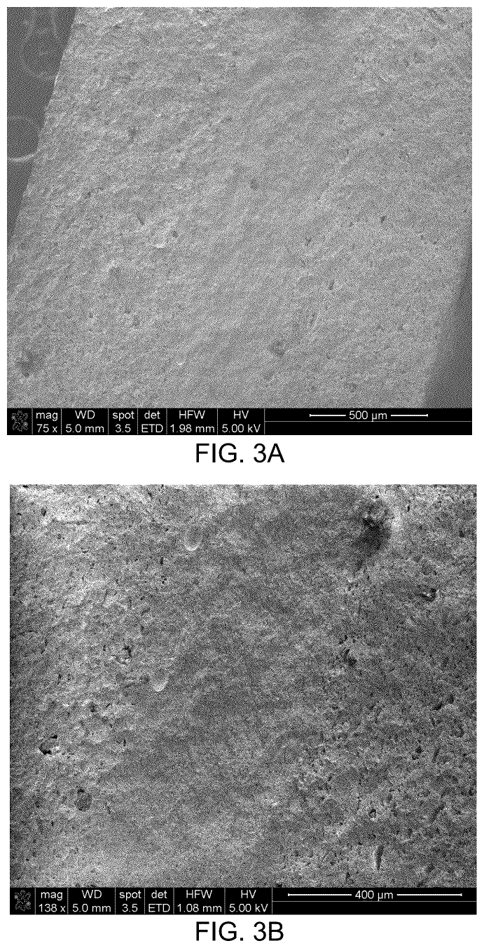

FIG. 3A and FIG. 3B are SEM images showing an anode precursor, an electrolyte precursor, and a cathode precursor after pore formers are vacated and before they are infiltrated. These precursors in FIG. 3A and FIG. 3B are YSZ, e.g., 3YSZ, 5YSZ, 7YSZ, 8YSZ, or combinations thereof. FIG. 3A shows a magnification at 75×; FIG. 3B shows a magnification at 138×. As can be clearly seen, the middle layer, i.e., the electrolyte precursor layer, has an average pore size that is 50% or less of the average pore size of the porous anode precursor and 50% or less of the average pore size of the porous cathode precursor.

In an embodiment, the process includes providing a porous substrate for the precursors as structural support. With reference to FIG. 1B, in some embodiments, the porous substrate is co-sintered with the infiltrated precursors in 120 and remains porous after co-sintering. In such cases, the electrolyte precursor has a thickness of no more than 30 μm, or no more than 10 μm, or no more than 5 μm; the anode precursor or the cathode precursor has a thickness of no more than 50 μm, or no more than 30 μm, or no more than 20 μm.

### Applications of Electrochemical Device

The electrochemical device as described herein has many applications. For example, the device is capable of performing water gas shift reactions electrochemically. The electrochemical reforming reactions involve the exchange of an ion through the membrane to oxidize the hydrocarbon. The electrochemical reactions involve the exchange of an ion through the membrane and include forward water gas shift reactions, or reverse water gas shift reactions, or both. These are different from traditional reforming reactions and water gas shift reactions via chemical pathways because they involve direct combination of reactants.

In an embodiment, device 100 is configured to receive CO or Hz and to generate CO/CO₂ or H₂O at the anode 101; device 100 is also configured to receive water or steam and to generate hydrogen at the cathode 102. In some cases, the cathode 102 receives a mixture of steam and hydrogen. Since water provides the oxide ion (which is transported through the membrane) needed to oxidize the CO or H₂ at the opposite electrode, water is considered the oxidant in this scenario although the environment around the cathode is reducing. As such, the anode 101 performs oxidation reactions in a reducing environment. In an embodiment, anode 101, cathode 102, and electrolyte 103 comprise Ni-YSZ. In various cases, gases containing H₂, CO, syngas, or combinations thereof are suitable as feed stream for anode 101. Alternatively, gases containing a hydrocarbon are reformed before coming into contact with the membrane 103/electrode 101. The reformer is configured to perform steam reforming, dry reforming, or combination thereof. The reformed gases are suitable as feed stream for anode 101.

FIG. 2A illustrates (not to scale) a tubular device 200, according to an embodiment of this disclosure. Tubular producer 200 includes an inner tubular structure 202, an outer tubular structure 204, and a membrane/electrolyte 206 disposed between the inner and outer tubular structures 202, 204, respectively. Tubular producer 200 further includes a void space 208 for fluid passage. FIG. 2B illustrates (not to scale) a cross section of a tubular producer 200, according to an embodiment of this disclosure. Tubular producer 200 includes a first inner tubular structure 202, a second outer tubular structure 204, and a membrane/electrolyte 206 between the inner and outer tubular structures 202, 204. Tubular producer 200 further includes a void space 208 for fluid passage.

In an embodiment, the electrodes and the membrane/electrolyte are tubular with the anode being outermost and the cathode being innermost, wherein the cathode is configured to receive water and hydrogen. In an embodiment, the electrodes and the membrane/electrolyte are tubular with the anode being innermost and the cathode being outermost, wherein the cathode is configured to receive water and hydrogen.

In an embodiment, the electrochemical device comprises a first electrode, a second electrode, and a membrane between the electrodes, wherein the first electrode and the second electrode comprise a metallic phase that does not contain a platinum group metal when the device is in use, and wherein the membrane is oxide ion conducting. In an embodiment, the first electrode is configured to receive a fuel. In an embodiment, said fuel comprises a hydrocarbon or hydrogen or carbon monoxide or combinations thereof. In an embodiment, the second electrode is configured to receive water and hydrogen and configured to reduce the water to hydrogen. In various embodiments, such reduction takes place electrochemically.

The electrochemical (EC) device as discussed above is also suitable to produce hydrogen from ammonia. A product from ammonia cracking comprises hydrogen and nitrogen and is sent to the anode of the EC device directly as the feed stream. In an embodiment, the device comprises porous electrodes that comprise metallic phase and ceramic phase, wherein the metallic phase is electronically conductive and wherein the ceramic phase is ionically conductive. In various embodiments, the electrodes have no current collector attached to them. In various embodiments, the device does not contain any current collector. Clearly, such a device is fundamentally different from any electrolysis device or fuel cell.

The electrochemical reactions taking place in the device comprise electrochemical half-cell reactions, wherein the half-cell reactions are:

H_{2(gas)}+O²⁻ [symbol] H₂O_{(gas)}+2e⁻ 1

H₂O_{(gas)}+2e⁻ [symbol] H_{2(gas)}+O²⁻ 2

In various embodiments, the half-cell reactions take place at triple phase boundaries, wherein the triple phase boundaries are the intersections of pores with the electronically conducting phase and the ionically conducting phase. Furthermore, the device is also capable of performing chemical water gas shift reactions. In various embodiments, the ammonia cracking product comprises hydrogen and nitrogen, wherein the hydrogen is a suitable fuel for the anode of the EC device. An advantage of this method and system is that the presence of nitrogen does not affect the performance of the EC device and the production of hydrogen on the cathode side.

It is to be understood that this disclosure describes exemplary embodiments for implementing different features, structures, or functions of the invention. Exemplary embodiments of components, arrangements, and configurations are described to simplify the present disclosure; however, these exemplary embodiments are provided merely as examples and are not intended to limit the scope of the invention. The embodiments as presented herein may be combined unless otherwise specified. Such combinations do not depart from the scope of the disclosure.

Additionally, certain terms are used throughout the description and claims to refer to particular components or steps. As one skilled in the art appreciates, various entities may refer to the same component or process step by different names, and as such, the naming convention for the elements described herein is not intended to limit the scope of the invention. Further, the terms and naming convention used herein are not intended to distinguish between components, features, and/or steps that differ in name but not in function.

While the disclosure is susceptible to various modifications and alternative forms, specific embodiments thereof are shown by way of example in the drawings and description. It should be understood, however, that the drawings and detailed description are not intended to limit the disclosure to the particular form disclosed, but on the contrary, the intention is to cover all modifications, equivalents and alternatives falling within the spirit and scope of this disclosure.

What is claimed is:

1. A method of making an electrochemical device comprising:
(a) infiltrating an anode precursor, a cathode precursor, and an electrolyte precursor with a dispersion to produce an infiltrated anode precursor, an infiltrated cathode precursor, and an infiltrated electrolyte precursor, wherein the dispersion comprises metal ions and nanoparticles selected from the group consisting of metallic nanoparticles, metal-oxide nanoparticles, ceramic nanoparticles, and combinations thereof; wherein the metal ions percolate each precursor,
wherein the anode precursor, the cathode precursor, and the electrolyte precursor are porous, the electrolyte precursor having an average pore size that is 50% or less of an average pore size of the anode precursor and that is 50% or less of an average pore size of the cathode precursor; and
(b) co-sintering the infiltrated anode precursor, the infiltrated cathode precursor, and the infiltrated electrolyte precursor such that the infiltrated anode precursor becomes a porous anode, the infiltrated cathode precursor becomes a porous cathode, and a gas tight electrolyte is formed between the porous anode and the porous cathode.

2. The method of claim 1, wherein the porous anode, the porous cathode, and the gas-tight electrolyte have the same elements.

3. The method of claim 1, wherein the gas-tight electrolyte conducts electrons and ions.

4. The method of claim 1, wherein the average pore size of the electrolyte precursor is in the range of 10-200 nm.

5. The method of claim 1, wherein an average pore size of the anode precursor is 20 nm-2 μm or the average pore size of the cathode precursor is 20 nm-2 μm.

6. The method of claim 1, wherein the anode precursor, the cathode precursor, and the electrolyte precursor are heated prior to the infiltration step such that pore formers present in the anode precursor, the cathode precursor, and the electrolyte precursor are vacated to produce pores in the anode precursor, the cathode precursor, and the electrolyte precursor.

7. The method of claim 1, wherein the anode precursor, the cathode precursor, and the electrolyte precursor comprise YSZ, CGO, SDC, SSZ, LSGM, ScCeSZ, or combinations thereof.

8. The method of claim 1, wherein the metal ions comprise nickel ions, copper ions, silver ions, cobalt ions, iron ions, or combinations thereof.

9. The method of claim 1, wherein the nanoparticles comprise nickel nanoparticles, NiO nanoparticles, CGO nanoparticles, CoCGO nanoparticles, YSZ nanoparticles, Copper nanoparticles, Copper Oxide nanoparticles, LST nanoparticles, SCZ nanoparticles, silver nanoparticles, LSCF nanoparticles, nickel/iron alloy nanoparticles, cobalt nanoparticles, platinum nanoparticles, ZrO₂ nanoparticles, CeO₂ nanoparticles, or combinations thereof.

10. The method of claim 1, wherein infiltration is prompted by applying a pressure differential, stirring, agitation, sonication, heating, capillary forces, solid-liquid cohesive forces, or a combination of any two or more thereof.

11. The method of claim 1, wherein co-sintering takes place in an inert atmosphere or a reducing atmosphere.

12. The method of claim 1 further comprising providing a porous substrate for at least one of the anode precursor, the cathode precursor, and the electrolyte precursor as structural support.

13. The method of claim 12, wherein the porous substrate is co-sintered with the infiltrated precursors and remains porous after co-sintering.

14. The method of claim 12, wherein the electrolyte precursor has a thickness of no more than 30 μm; and wherein the anode precursor has a thickness of no more than 50 μm, and wherein the cathode precursor has a thickness of no more than 50 μm.

15. The method of claim 1, wherein the porous anode and the porous cathode have a porosity of no less than 20 vol. %.

16. The method of claim 1, wherein the electrochemical device comprises no current collector and no interconnect.

17. The method of claim 1, wherein the porous anode, the porous cathode, and the gas-tight electrolyte are tubular.

18. An electrochemical device comprising a porous anode, a porous cathode, and an electrolyte disposed between the porous anode and the porous cathode; wherein the porous anode, the porous cathode, and the electrolyte have the same elements, wherein the electrolyte is gas tight and conducts electrons and ions, and wherein the device comprises no current collector and no interconnect.

19. The device of claim 18, wherein the porous anode, porous cathode, and electrolyte comprise a ceramic matrix percolated by a metal.

20. The device of claim 18 comprising a porous substrate as structural support.
